(19) United States
(12) Patent Application Publication
(10) Pub. No.: US 2013/0109569 A1
(43) Pub. Date: May 2, 2013

(54) STABLE PESTICIDAL COMPOSITIONS

(71) Applicant: Dow AgroSciences LLC, Indianapolis, IN (US)

(72) Inventors: Hiteshkumar Dave, Carmel, IN (US); Lei Liu, Carmel, IN (US); Ashish Batra, Indianapolis, IN (US); Martin C. Logan, Indianapolis, IN (US); Raymond E. Boucher, JR., Lebanon, IN (US); John M. Atkinson, Zionsville, IN (US); Eric Paterson, Grimston (GB); Franklin N. Keeney, Carmel, IN (US); Robert Matthew Buttimor, Spotswood (NZ); Melissa Gail Olds, Zionsville, IN (US); Holger Tank, Zionsville, IN (US); Stephen L. Wilson, Zionsville, IN (US); Roger E. Gast, Zionsville, IN (US); David G. Ouse, Indianapolis, IN (US); James M. Gifford, Lebanon, IN (US); Ãndrea Christine McVeigh-Nelson, Indianapolis, IN (US)

(73) Assignee: DOW AGROSCIENCES LLC, Indianapolis, IN (US)

(21) Appl. No.: 13/664,911

(22) Filed: Oct. 31, 2012

Related U.S. Application Data
(60) Provisional application No. 61/554,005, filed on Nov. 1, 2011.

(51) Int. Cl. A01N 43/40; A01N 33/18; A01P 13/00; A01P 3/00; A01P 7/04; A01N 47/08; A01N 25/28; B82Y 99/00

(52) U.S. Cl. 504/130; 504/148; 504/255; 504/355; 504/359; 977/788; 977/902

(57) ABSTRACT

Provided herein are high-load, solid and liquid pesticidal compositions containing a low-melting active ingredient, which exhibit good physical and chemical stability, and equivalent or improved biological efficacy compared to liquid compositions when used to control pests in crop or non-crop environments.

### CROSS-REFERENCE TO RELATED APPLICATION

This application claims priority to U.S. Provisional Patent Application Ser. No. 61/554,005, filed Nov. 1, 2011, the disclosure of which is hereby incorporated herein in its entirety by this reference.

### FIELD

Provided herein are stable high-load herbicidal solid (e.g., dispersible granules or powders) or aqueous compositions containing low-melting active ingredients, as well as methods for their preparation and use. Such compositions exhibit good physical and chemical stability, and equivalent or better biological efficacy on target pests when compared to commercial formulations.

### BACKGROUND

There are two major categories of formulations, solid formulations and liquid formulations. Agrochemical formulations are generally designed based on customer needs and the physiochemical properties of the active ingredients, for example, the solubility of the active ingredient in water or non-aqueous solvents and the melting point of the active ingredient.

Granular products containing agricultural active ingredients such as, for example, water dispersible granules (WG) and granules (GR), represent a class of formulations that are seeing increased use today because of their relative safety compared to liquid formulations and the advantages they offer with regard to cost savings in packaging and transportation, and the environmental benefits of eliminating the use of organic solvents. WG formulations are designed to readily disperse on contact with the water carrier in a spray tank and provide equivalent performance to an emulsifiable concentrate product. GR formulations may be added directly to soil or aquatic environments such as, for example, rice paddies. WG and GR products may be used for insect, weed, fungal pathogen and nematode control.

Solid pesticidal compositions containing low-melting active ingredients can be difficult to produce and store due to the tendency of the active ingredient to liquefy and/or crystallize when subjected to the range of temperatures normally encountered during processing and storage. In addition, these compositions must readily disperse in water when added to a spray tank of water prior to spray application.

Agricultural water dispersible granules containing active ingredients also may contain inert ingredients such as solid carriers, surfactants, adjuvants, binders and the like. These inert ingredients may include, for example, clays, starches, silicas, sulphates, chlorides, lignosulfonates, carbohydrates, alkylated celluloses, xanthan gums and guar seed gums, and synthetic polymers such as polyvinyl alcohols, sodium polyacrylates, polyethylene oxides, polyvinylpyrrolidones and urea/formaldehyde polymers like PergoPak® M (Albemarle Corporation, Baton Rouge, La.). The active ingredients contained in WG products may include herbicides, insecticides, fungicides, plant growth regulators and safeners.

Described herein are high-load, solid and aqueous pesticidal compositions containing low-melting active ingredients and methods for their preparation and use. Such compositions exhibit good physical and chemical stability, readily disperse in water for spray application to control pests and exhibit equivalent or better biological efficacy when compared to standard commercial formulations.

### SUMMARY

Provided herein are stable, high-load, solid pesticidal compositions containing a low-melting active ingredient comprising:
1) a microcapsule comprising (a) a water insoluble, thin-wall polyurea shell prepared by an interfacial polycondensation reaction between a water soluble polyamine monomer and an oil soluble polyisocyanate monomer and (b) a core comprising a low melting active ingredient, wherein
   (i) the ratio of amino moieties to isocyanate moieties is about 1:1;
   (ii) the polyurea shell has a thickness of greater than about 10 nanometers (nm) and less than about 60 nm;
   (iii) the average microcapsule size is from about 1 micrometers (μm) to about 25 μm;
   (iv) the weight ratio of the core to the polyurea shell is from about 2 to about 165; and
   (v) the microcapsule is present in an amount, with respect to the total composition, from about 300 g/kg to about 900 g/kg;
2) a solid, water soluble, polymeric stabilizer present in an amount, with respect to the total composition, of from about 5 g/kg to about 250 g/kg; and
3) a solid emulsifying or solid dispersing surfactant present in an amount, with respect to the total composition, from about 5 g/kg to about 300 g/kg.

Also provided herein are stable, high-load, aqueous herbicidal concentrates containing a low-melting active ingredient comprising:
1) a microcapsule consisting of (a) a water insoluble, thin-wall polyurea shell prepared by an interfacial polycondensation reaction between a water soluble polyamine monomer and an oil soluble polyisocyanate monomer and (b) a core comprising a low melting active ingredient, wherein
   (i) the ratio of amino moieties to isocyanate moieties is about 1:1;
   (ii) the polyurea shell has a thickness of greater than about 20 nanometers (nm) and less than about 75 nm;
   (iii) the average microcapsule size is from about 10 micrometers (μm) to about 25 μm;
   (iv) the weight ratio of the core to the polyurea shell is from about 2 to about 165;
   (v) the low-melting active ingredient is present in an amount of from about 200 g/L to about 750 g/L; and
   (vi) the core comprises no more than 5% of oil solvent with respect to the total weight of the core; and
2) a solid emulsifying or solid dispersing surfactant present in an amount, with respect to the total composition, from about 5 g/L to about 150 g/L.

The described solid pesticidal compositions and aqueous herbicidal concentrates may optionally include one or more additional inert formulation ingredients that may be contained inside or outside of the microcapsule.

In certain embodiments, the described solid pesticidal compositions may optionally include a built-in adjuvant to provide improved biological efficacy when the solid pesticidal compositions are used to control pests such as weeds, insects, fungal pathogens and the like.

Also provided herein are methods of controlling undesirable vegetation, fungal pathogens or insects which comprise adding the respective solid pesticidal composition or aqueous herbicidal concentrate to a carrier such as water and using the resulting water solution containing the dispersed pesticidal or herbicidal active ingredient for spray applications to control undesirable vegetation, fungal pathogens or insects in crop or non-crop environments.

Also provided herein are methods for producing the described solid pesticidal compositions and aqueous herbicidal concentrates.

### DETAILED DESCRIPTION

Agricultural active ingredients that have low melting points can be difficult to formulate into solid compositions owing to their propensity to melt during processing or to crystallize into larger particles because of Ostwald ripening. In addition, preparing such formulations that have acceptable storage stability profiles can be very challenging. This situation is particularly difficult when the need is to prepare a product containing a high concentration or high-load of the low-melting active ingredient as is often necessary for products in the current market for agricultural chemicals. In addition, these solid agricultural compositions must readily disperse in water when added to a spray tank and provide equivalent or better biological efficacy when compared to liquid based agricultural formulations.

### I. SOLID COMPOSITIONS

Stable solid pesticidal compositions, such as granules and powders, are generally defined as those that are stable physically and chemically to the environments in which they are produced and stored, and deliver acceptable levels of biological efficacy when used within defined periods of time.

The solid pesticidal compositions described herein contain high levels of a low-melting pesticidal active ingredient that is contained within a polymer stabilized, thin-walled, polyurea microcapsule. In some embodiments, such compositions offer improved chemical and physical stability during processing and storage and readily disperse when added to a spray tank of water prior to spray application where they provide acceptable levels of biological activity when used to control targeted pests.

The solid pesticidal compositions described herein may be in the form of a water dispersible granule or a water dispersible powder and are comprised of a thin-walled, polyurea microcapsule containing a low-melting pesticidal active ingredient, a water soluble polymeric stabilizer, an emulsifying or dispersing surfactant and, optionally, other inert formulation ingredients.

The term “inert formulation ingredient” as used herein refers to any ingredient in a pesticidal composition or formulation other than the pesticidal active ingredient. Inert formulation ingredients, in certain embodiments, do not exhibit much if any biological activity on their own, but instead improve the effectiveness of the pesticidal composition. Inert formulation ingredients in certain embodiments, improve the uptake of an active ingredient into a target pest organism, improve the shelf-life of a pesticide product, or protect an active ingredient from breakdown in sunlight after spray application.

A. Low-Melting Active Ingredients

The low-melting, pesticidal active ingredient of the described solid pesticidal compositions may be selected from one or more of an herbicide, an insecticide, a fungicide and a bactericide. In addition, an herbicide safener may be included as an active ingredient in the described compositions. The low-melting active ingredient should be chemically stable in the molten phase and amenable to aqueous microencapsulation chemistry as described herein. In some embodiments, the low-melting, pesticidal active ingredient has a melting point of less than about 100° C., less than about 85° C., or less than about 70° C. In some embodiments, the active ingredient is a solid at ambient temperature (i.e., from about 20 to about 30° C.). In some embodiments, the low-melting pesticidal active ingredient, in some embodiments, has a water solubility of less than about 3000 parts per million (ppm), less than about 1000 ppm, or less than about 100 ppm at environmental pH conditions (pH of about 6.5 to about 7.5). In some embodiments, the low-melting pesticidal active ingredient is present in an amount, with respect to the total composition, from about 250 grams active ingredient per kilogram (gai/kg) to about 850 gai/kg, from about 365 gai/kg to about 800 gai/kg, or from about 500 gai/kg to about 800 gai/kg.

Suitable herbicide active ingredients for use in the described solid compositions may be selected from the following active ingredients and derivatives thereof such as, for example, esters and salts, but are not limited to, aclonifen, alachlor, ametryn, anilofos, atraton, aziprotryne, barban, beflubutamid, benazolin, benfluralin, benfuresate, bensulide, benzoylprop, bifenox, bromoxynil, butralin, butroxydim, chlorbromuron, chlorbufam, chlorpropham, clodinafop, clofop, clomazone, credazine, cycloxydim, cyhalofop, desmetryn, di-allate, diclofop, diethatyl, dimepiperate, dimethachlor, dimethametryn, dinitramine, dinoseb, dithiopyr, ethalfluralin, ethofumesate, etobenzanid, fenoxaprop, fenoxaprop-P, fenthiaprop, fentrazamide, flamprop, flamprop-M, fluazolate, fluchloralin, flufenacet, flumiclorac, fluorochloridone, fluorodifen, fluoroglycofen, fluoroxypyr, haloxyfop, haloxyfop-P, indanofan, ioxynil, isocarbamid, lactofen, linuron, MCPA, MCPB, mecoprop, mecoprop-P, medinoterb, metamifop, metazachlor, methoprotryne, methoxyphenone, methyldymron, metobromuron, monalide, monolinuron, napropamide, nitrofen, oxadiazon, oxyfluorfen, pendimethalin, pentanochlor, pethoxamid, profluralin, prometon, propachlor, propanil, propaquizafop, propham, pyributicarb, pyridate, quizalofop, quizalofop-P, secbumeton, simetryn, tepraloxydim, thenylchlor, thiazopyr, tri-allate, tridiphane, trifluralin. Especially suitable herbicide active ingredients include benfluralin, bromoxynil, cyhalofop, cyhalofop-butyl, clodinafop, diclofop, dithiopyr, ethalfluralin, fenoxaprop, fenoxaprop-P, flufenacet, fluoroxypyr, haloxyfop, haloxyfop-P, indanofan, ioxynil, MCPA, mecoprop, mecoprop-P, metamifop, oxyfluorfen, pendimethalin, propanil, quizalofop, quizalofop-P, tepraloxydim and trifluralin.

Suitable insecticide active ingredients for use in the described solid compositions may be selected from the following active ingredients and derivatives thereof such as, for example, esters and salts, but are not limited to, acephate, acetamiprid, acrinathrin, alanycarb, aldicarb, aminocarb, amitraz, amphur, azamethiphos, azinphos-ethyl, azinphos-methyl, bensultap, bifenthrin, bioresmethrin, bromophos, bufencarb, butocarboxim, butoxycarboxim, chlordimeform, chlorfenapyr, chlorphoxim, chlorpyrifos, chlorpyrifos-methyl, cismethrin, cloethocarb, coumaphos, crufomate, cyanofenphos, cyfluthrin, beta-cyfluthrin, gamma-cyhalothrin, lambda-cyhalothrin, cypermethrin, alpha-cypermethrin, beta-cypermethrin, theta-cypermethrin, deltamethrin, demeton-S-methylsulphon, dialifos, dimethoate, dimetilan, dinoseb, dioxabenzofos, DNOC, EPN, esfenvalerate, ethiofencarb, etofenprox, fenchlorphos, fenfluthrin, fenobucarb, fenoxycarb, fenpropathrin, fenvalerate, fluenetil, formothion, fosmethilan, indoxacarb, isoprocarb, jodfenphos, leptophos, mecarphon, methamidophos, methidathion, methomyl, metolcarb, mexacarbate, nitenpyram, parathion-methyl, permethrin, phosalone, phosfolan, phosmet, pirimicarb, promecarb, propoxur, prothoate, pyridaphenthion, pyrimidifen, pyriproxyfen, quinalpho, resmethrin, spirodiclofen, spiromesifen, sulfluramid, tefluthrin, temephos, tetramethrin, thiofanox, tolfenpyrad, transfluthrin, triazamate, trichlorfon, vamidothion, XMC, xylylcarb and combinations thereof. Especially suitable insecticide active ingredients include acephate, acetamiprid, bifenthrin, chlorfenapyr, chlorpyrifos, chlorpyrifos-methyl, lambda-cyhalothrin, deltamethrin, indoxacarb, methomyl, phosmet, spirodiclofen and tolfenpyrad.

Suitable fungicide active ingredients for use in the described solid compositions may be selected from the following active ingredients and derivatives thereof such as, for example, esters and salts, but are not limited to, bromuconazole, bupirimate, carboxin, cyflufenamid, cyprodinil, difenoconazole, etaconazole, fenoxanil, flusilazole, hymexazol, imazalil, imibenconazole, iminoctadine, isoprothiolane, mandipropamid, mepronil, metalaxyl, metrafenone, myclobutanil, orysastrobin, penconazole, -picoxystrobin, prochloraz, propamocarb, proquinazid, pyraclostrobin, pyrimethanil, silthiofam, tolclofos-methyl, tolylfluanid, triadimefon, trifloxystrobin, triflumizole, Especially suitable fungicide active ingredients include flusilazole, myclobutanil, penconazole, proquinazid, pyraclostrobin, trifloxystrobin and triflumizole.

Suitable herbicide safeners for use in the described solid pesticidal compositions may be selected from the following active ingredients and derivatives thereof such as, for example, esters and salts, but are not limited to, cloquintocet-mexyl, cyometrinil, dimepiperate, fenclorim, flurazole, furilazole, mefenpyr-diethyl, oxabetrinil and TI-35. Especially suitable herbicide safeners include cloquintocet-mexyl, cyometrinil, flurazole, mefenpyr-diethyl and TI-35.

Suitable bactericide active ingredients for use in the described solid pesticidal compositions may include, but are not limited to, nitrapyrin, oxolinic acid, 8-hydroxyquinoline and derivatives thereof. An especially suitable bactericide active ingredient is nitrapyrin.

B. Polymeric Stabilizers

The solid, water soluble polymeric stabilizer for use in the described solid pesticidal compositions includes one or more of a synthetic or partially synthetic polymer or oligomer that swells, disperses or dissolves in water at ambient temperature. Typical solid, water soluble polymeric stabilizers include polyvinyl alcohols, polyacrylates, polyethylene oxides, polyvinylpyrrolidones, alkylated celluloses and co-polymers, derivatives and mixtures thereof. Particularly suitable solid, water soluble polymeric stabilizers for use in the described solid pesticidal compositions include polyvinyl alcohols derived from the hydrolysis of polyvinyl acetate, that vary in the degree of hydrolysis from about 87 to about 97%, of which Selvol® 205 (Sekisui Chemical Co., Ltd.) is an example, polyvinylpyrrolidones and co-polymers, derivatives and mixtures thereof.

The solid, water soluble, polymeric stabilizer may serve as both a dispersing agent for preparing the microcapsules described herein and as a stabilizer for the microcapsules when they are dried to form the solid pesticidal compositions. For such a dual use, the solid polymeric stabilizer may be added in more than one portion and at different times during the preparation of the microcapsules and the solid pesticidal compositions as described herein. The solid, water soluble, polymeric stabilizer for use in the described compositions comprises, with respect to the total composition, in some embodiments is present in an amount from about 5 grams per kilogram (g/kg) to about 250 g/kg, from about 20 g/kg to about 150 g/kg, or from about 50 g/kg to about 250 g/kg. In one embodiment, the solid, water soluble, polymeric stabilizer is present in an amount of from about 20 g/kg to about 50 g/kg.

C. Emulsifying or Dispersing Surfactants

The solid, emulsifying or dispersing surfactant for use in the described solid pesticidal compositions may include one or more of an alkyl polyglycoside (APG), a polyol fatty acid ester, a polyethoxylated ester, a polyethoxylated alcohol, an amine ethoxylate, a sorbitan fatty acid ester, a dialkylsulphosuccinate salt, an alkylsulfonate salt, a lignosulfonate salt, a sucrose ester of a fatty acid, and mixtures thereof. Particularly suitable solid, emulsifying or dispersing surfactants include APG surfactants such as, for example, Agnique®PG 9116 (Cognis, Cincinnati, Ohio), lignosulfonate salts such as, for example, Borresperse NA (Borregaard LignoTech, Bridgewater, N.J.) or Polyfon® F (MeadWestvaco, Richmond, Va.), sucrose esters of fatty acids such as, for example, oleate or caprylate esters of sucrose and sodium dioctyl sulphossuccinate which is found in Geropon® SDS (Rhodia, Cranberry, N.J.). In some cases, the solid emulsifying surfactant may also serve in the additional role as a built-in adjuvant to improve the uptake of the pesticide active ingredient into the target pest organism. In some embodiments the solid, emulsifying or dispersing surfactant for use in the described solid pesticidal compositions comprises, with respect to the total composition, from about 5 g/kg to about 300 g/kg, 5 g/kg to about 250 g/kg, 5 g/kg to about 150 g/kg or 5 g/kg to about 100 g/kg. In some embodiments, the solid emulsifying or dispersing agent is present in an amount of from about 200 g/kg or 250 g/kg. In one embodiment, the solid emulsifying or dispersing agent is present in an amount of from about 200 g/kg or 250 g/kg and the low melting active ingredient is fluoroxypyr or derivative thereof.

In some embodiments of the described solid pesticidal compositions, a polyvinyl alcohol derived from the hydrolysis of a polyvinyl acetate and a lignosulfonate salt when used together are particularly useful in providing emulsification, dispersion and microcapsule stabilization in the preparation, storage and use of the described solid pesticidal compositions. It is well known in the art that certain inert formulation ingredients or combinations thereof can exhibit multi-functional behavior and act, for example, as emulsifiers, dispersants and/or stabilizers within a single composition.

### II. AQUEOUS COMPOSITIONS

Also described herein is a stable, high load, aqueous herbicidal concentrate comprising a microencapsulated, low melting, herbicide active ingredient and a solid, emulsifying or dispersing surfactant. Such a composition would be prepared as described herein by a polyurea microencapsulation of the molten herbicidal active ingredient to provide an initial capsule suspension that would then be treated with one or more finishing ingredients such as, for example, a rheology agent and a biocide. Such an aqueous herbicidal concentrate shows improved storage stability and acceptable herbicidal efficacy when compared to a commercial emulsifiable concentrate (EC) formulation containing the low melting, herbicide active ingredient without the drawbacks of having to use large amounts of volatile, flammable and potentially toxic organic solvents.

A. Low-Melting Active Ingredients

In some embodiments the low melting, herbicide active ingredient used in the aqueous herbicidal concentrates described herein is normally a solid at room temperature, has a melting of less than about 70° C. and may be selected from at least one of benfluralin, ethalfluralin, pendimethalin and/or trifluralin. In some embodiments the active ingredient is benfluralin.

In some embodiments the aqueous herbicidal concentrate comprises from about 200 grams per liter (g/L) to about 750 g/L of the low melting herbicide active ingredient. In some embodiments the aqueous herbicidal concentrate comprises from about 300 g/L to about 600 g/L of the low melting herbicide active ingredient. In some embodiments the aqueous herbicidal concentrate comprises from about 400 g/L to about 600 g/L of the low melting herbicide active ingredient.

B. Emulsifying or Dispersing Surfactant

The solid, emulsifying or dispersing surfactant for use in the aqueous herbicidal concentrate described herein may include one or more of a polyvinyl alcohol, a polyacrylate, a polyethylene oxide, a polyvinylpyrrolidone and co-polymers, derivatives and mixtures thereof. Exemplary solid, emulsifying or dispersing surfactants for use in the described herbicidal concentrate include polyvinyl alcohols derived from the hydrolysis of polyvinyl acetate that vary in the degree of hydrolysis from about 87 to about 97%, of which Selvol® 205 (Sekisui Chemical Co., Ltd.) is an example, polyvinylpyrrolidones and co-polymers, derivatives and mixtures thereof. The solid, emulsifying or dispersing surfactant for use in the aqueous herbicidal concentrate comprises, with respect to the total composition, from about 5 g/kg to about 250 g/kg, preferably from about 5 g/kg to about 150 g/kg and most preferably from about 5 g/kg to about 100 g/kg. In one embodiment, the solid, emulsifying or dispersing surfactant is present in an amount of from about 5 g/kg to about 15 g/kg.

### III. OPTIONAL INERT INGREDIENTS

A. Built-in Adjuvants

Adjuvants are important inert ingredients of formulated agricultural products and are defined as substances which can increase the biological activity of the active ingredient, but are themselves not significantly biologically active. Adjuvants assist with the effectiveness of the active ingredient such as, for example, by improving the delivery and uptake of an herbicide into a target weed plant leading to improved biological control.

Adjuvants, in the form of solids or liquids, can be added to a formulated agricultural product, such as a granule, to provide improved performance of the product upon application. Commonly used adjuvants may include, for example, surfactants, spreaders, petroleum and plant derived oils and solvents and wetting agents. Examples of commonly used adjuvants include, but are not limited to, paraffin oil, horticultural spray oils (e.g., summer oil), methylated rape seed oil, methylated soybean oil, highly refined vegetable oil and the like, polyol fatty acid esters, polyethoxylated esters, ethoxylated alcohols, alkyl polysaccharides and blends, amine ethoxylates, sorbitan fatty acid ester ethoxylates, polyethylene glycol esters, organosilicone based surfactants, ethylene vinyl acetate terpolymers, ethoxylated alkyl aryl phosphate esters and the like. These and other adjuvants are described in the “Compendium of Herbicide Adjuvants, 9th Edition,” edited by Bryan Young, Dept. of Plant, Soil and Agricultural Systems, Southern Illinois University MC-4415, 1205 Lincoln Drive, Carbondale, Ill. 62901, which is available for viewing on the internet at http://www.herbicide-adjuvants.com/.

The term “built-in adjuvant” refers to one or more adjuvants that have been added to a particular formulation, such as a granule or liquid formulation, at the manufacturing stage of the product, rather than at the point of use of the product such as, for example, to a spray solution. The use of built-in adjuvants simplifies the use of agrochemical products for the end-user by reducing the number of ingredients that must be individually measured and applied. However, loading limitations and physio-chemical properties of active ingredients can make it challenging to add an adjuvant to a composition. Efforts to prepare pesticidal formulations with built-in alkyl polyglucosides amongst other adjuvants, have recently been disclosed, for example, in WO2010/049070A2 and WO2008/066611.

In some embodiments the addition of a solid, built-in adjuvant to the solid, pesticidal compositions described herein may provide improved biological efficacy on pests such as, for example, weeds, insects, fungal pathogens and the like. The solid, built-in adjuvant is added as an inert ingredient to the solid, pesticidal composition, but is located outside of the microcapsule that contains the low-melting active ingredient. Suitable built-in adjuvants for use in the described compositions are solids at ambient temperature and may include one or more than one of a non-ionic surfactant. Non-ionic surfactants that may be used include, but are not limited to, polyol fatty acid esters, polyethoxylated esters, polyethoxylated alcohols, alkyl polysaccharides such as alkyl polyglycosides (APG-type) and blends thereof, amine ethoxylates, sorbitan fatty acid ester ethoxylates and sucrose esters of fatty acids. Especially suitable solid, built-in adjuvants include alkyl polysaccharides such as alkyl polyglycosides and blends thereof, amine ethoxylates, sorbitan fatty acid ester ethoxylates, and sucrose esters of fatty acids. The solid, built-in adjuvant, which may also serve as the emulsifying or dispersing surfactant, for use in the described solid, pesticidal composition comprises, with respect to the total composition, from about 10 g/kg to about 250 g/kg, preferably from about 10 g/kg to about 150 g/kg and most preferably from about 20 g/kg to about 150 g/kg.

In some embodiments the solid pesticidal composition containing a low-melting active ingredient comprises fluoroxypyr-meptyl and a solid, emulsifying surfactant from the class of alkyl polyglycosides that may also serve as a built-in adjuvant.

B. Other Inert Ingredients

The solid pesticidal compositions and aqueous herbicidal concentrates described herein may optionally include one or more inert ingredients such as, but not limited to, adjuvants, antifoam agents, antimicrobial agents, compatibilizing agents, corrosion inhibitors, dispersing agents, dyes, emulsifying agents, neutralizing agents and buffers, odorants, penetration aids, processing additives, inorganic salts of organic or inorganic acids, sequestering agents, spreading agents, stabilizers, sticking agents, suspension aids, wetting agents, and the like. In some embodiments the one or more inert ingredients stabilize or further stabilize the composition. In some embodiments one or more inorganic salts of organic or inorganic acid is present in the composition. In some embodiments these salts decrease the solubility of the active ingredient in the aqueous phase. In some embodiments sodium acetate decreases the solubility of the active ingredient in the aqueous phase. In some embodiments sodium acetate decreases the solubility of benfluralin in the aqueous phase. In some embodiments, the solid compositions comprise ammonium sulfate.

### IV. MICROCAPSULE

The microencapsulated, low-melting, pesticidal and herbicidal active ingredients contained in the described solid pesticidal compositions and aqueous herbicidal concentrates, respectively, are prepared by employing interfacial polycondensation encapsulation technology. Use of such encapsulation technology in the formulation of agricultural active ingredients is well known to those skilled in the art. See, for example, P. J. Mulqueen in, “Chemistry and Technology of Agrochemical Formulations,” D. A. Knowles, editor, (Kluwer Academic Publishers, 1998), pages 132-147, and references cited therein for a discussion of the use of microencapsulation in the formulation of pesticide active ingredients. In general, the microcapsules can be prepared by an interfacial polycondensation reaction between at least one oil soluble monomer selected from the group consisting of diisocyanates and polyisocyanates, and at least one water soluble monomer selected from the group consisting of diamines and polyamines. Typical microcapsule formulations are derived, for example, from the interfacial polycondensation between polyisocyanates and diamines to provide polyurea microcapsule compositions.

The microencapsulated, low-melting pesticidal and herbicidal active ingredients of the described compositions may be prepared by first emulsifying an organic phase comprised of the molten active ingredient, optionally containing an oil solvent, and an oil soluble monomer in an aqueous phase comprised of suitable surfactants and water. The emulsion may be formed by homogenizing the oil-water mixture by the use of low or high pressure homogenization until the desired size of oil droplets suspended in the water is obtained. The water soluble monomer is then added to the mixture and reacts with the oil soluble monomer at the water-oil interface of the oil droplet to form the capsule wall enclosing some or the entire oil droplet. For example, by carefully adjusting the length of time that the mixture is homogenized and/or by adjusting the speed or pressure of the homogenizer, it is possible to produce microencapsulated oils of varying capsule sizes (measured as the volume median diameter by a light scattering particle analyzer) and wall thicknesses. Similarly, the amount of monomer, cross-linking agents, emulsifying agents, buffer, and the like can be adjusted to create microencapsulated formulations having varying capsule sizes and wall thicknesses that can be readily prepared by one of ordinary skill in the art.

With respect to the polycondensation reaction between a oil soluble polyisocyante and water soluble polyamine monomers, the ratio of amino moieties (i.e., functional groups) to isocyanate moieties. i.e., molar ratio of amino moieties to isocyanate moieties, is about 1:1. In certain embodiments, the isocyanate and polyamine moieties are fully reacted. In some embodiments, the ratio is from about 0.9:1.0 to about 1.0:0.9. In some embodiments the ratio is from about 0.95:1.0 to about 1.0:0.95. In some embodiments the ratio is from about 0.97:1.0 to about 1.0:0.97. In some embodiments the ratio is from about 0.98:1.0 to about 1.0:0.98. In some embodiments the ratio is from about 0.99:1.0 to about 1.0:0.99.

The microcapsules of the described solid pesticidal compositions generally include capsules with average diameters (sizes) that range from about 1 μm to about 10 μm, preferably from about 2 μm to about 5 μm, and have a shell thickness that ranges from about 10 nanometers (nm) to about 60 nm, preferably from about 15 nm to about 40 nm.

With respect to the solid and aqueous compositions, in certain embodiments, the weight ratio of the core of the microcapsule to the polyurea shell of the microcapsule is from about 2 to about 165 or from about 5 to about 60. In certain embodiments, the weight ratio is from about 5 to about 150, from about 5 to about 100, from about 10 to about 80, from about 60 to about 100, from about 70 to about 90, or about 80. In certain embodiments, the weight ratio is from about 75 to about 85. In certain embodiments, the weight ratio is from about 75 to about 85, and the low-melting active ingredient is benfluralin. In certain embodiments, the weight ratio is from about 10 to about 20, and the low-melting active ingredient is fluoroxypyr or derivative thereof.

In some embodiments of the solid compositions described herein, the average microcapsule size is from about 1 μm to about 20 μm. In some embodiments of the solid compositions described herein, the average microcapsule size is from about 1 μm to about 10 μm. In some embodiments of the solid compositions described herein, the average microcapsule size is from about 1 μm to about 5 μm. In some embodiments of the solid compositions described herein, the average microcapsule size is from about 1 μm to about 5 μm and the low melting active ingredient is fluoroxypyr. In some embodiments of the solid compositions described herein, the average microcapsule size is from about 15 μm to about 20 μm. In some embodiments of the solid compositions described herein, the average microcapsule size is from about 15 μm to about 20 μm, and the low-melting active ingredient is benfluralin.

In some embodiments of the solid compositions described herein, the polyurea shell has a thickness of about 20 nm to about 40 nm. In some embodiments of the solid compositions described herein, the polyurea shell has a thickness of about 10 nm to about 50 nm, about 15 nm to about 40 nm, about 20 nm to about 30 nm, or about 30 nm to about 35 nm. In some embodiments, the thickness is from about 20 nm to about 30 nm and the low-melting active is benfluralin. In some embodiments, the thickness is from about 30 nm to about 40 nm and the low-melting active is fluoroxypyr-meptyl.

In some embodiments of the aqueous compositions described herein, the polyurea shell has a thickness of about 20 nm to about 40 nm. In some embodiments of the aqueous compositions described herein, the polyurea shell has a thickness of about 15 nm to about 45 nm. In some embodiments of the aqueous compositions described herein, the polyurea shell has a thickness of about 10 nm to about 50 nm, about 15 nm to about 40 nm, about 20 nm to about 30 nm, or about 30 nm to about 35 nm.

In some embodiments of the aqueous compositions described herein, the average microcapsule size is from about 15 μm to about 20 μm. In some embodiments of the aqueous compositions described herein, the average microcapsule size is from about 17.5 μm.

In some embodiments the capsules of the solid pesticidal compositions and the aqueous herbicidal concentrates have sizes that range from about 1 μm to about 25 μm. In some embodiments the capsules may have sizes that range from about 15 μm to about 25 μm. In some embodiments the capsules may have sizes that range from about 15 μm to about 20 μm.

In some embodiments the capsules of the aqueous herbicidal concentrates have a shell thickness that ranges from about 20 nm to about 75 nm. In some embodiments the capsules have a shell thickness that ranges from about 20 nm to about 50 nm. In some embodiments the capsules have a shell thickness that ranges from about 25 nm to about 45 nm.

The core, which includes all of the material in the microcapsule minus the shell material, of the microcapsule of the described compositions, both the solid pesticidal compositions and the aqueous herbicidal concentrates, comprises the molten or solid pesticidal or herbicidal active ingredient, optionally dissolved in or diluted with an oil solvent, such as but not limited to, one or more of petroleum distillates such as aromatic hydrocarbons derived from benzene, such as toluene, xylenes, other alkylated benzenes and the like, and naphthalene derivatives; aliphatic hydrocarbons such as hexane, octane, cyclohexane, and the like; mineral oils from the aliphatic or isoparaffinic series, and mixtures of aromatic and aliphatic hydrocarbons; halogenated aromatic or aliphatic hydrocarbons; vegetable, seed or animal oils such as soybean oil, rape seed oil, olive oil, castor oil, sunflower seed oil, coconut oil, corn oil, cotton seed oil, linseed oil, palm oil, peanut oil, safflower oil, sesame oil, tung oil and the like, and C₁-C₆ mono-esters derived from vegetable, seed or animal oils; dialkyl amides of short and long chain, saturated and unsaturated carboxylic acids; C₁-C₁₂ esters of aromatic carboxylic acids and dicarboxylic acids, and C₁-C₁₂ esters of aliphatic and cyclo-aliphatic carboxylic acids. In some embodiments, the microcapsule comprises no more than 5, 4, 3, 2, or 1 wt percent with respect to the weight of the core. In one embodiment, the microcapsule comprises no more than 1 wt percent. In one embodiment, the microcapsule comprises no more than 3 wt percent.

The core of the microcapsule of the described compositions may optionally be used as a carrier for additional pesticides or other ingredients. These pesticides or other ingredients, may be dissolved or dispersed in the core material, and may be selected from acaricides, algicides, antifeedants, avicides, bactericides, bird repellents, chemosterilants, fungicides, herbicide safeners, herbicides, insect attractants, insecticides, insect repellents, mammal repellents, mating disrupters, molluscicides, plant activators, plant growth regulators, rodenticides, synergists, defoliants, desiccants, disinfectants, semiochemicals, and virucides.

Oil soluble monomers used to prepare the microcapsule of the described compositions include the groups consisting of diisocyanates and polyisocyanates. Particularly suitable oil soluble monomers are diisocyanates and polyisocyanates such as, for example, PAPI® 27 (The Dow Chemical Company, Midland, Mich.), isophorone diisocyanate, hexamethylene diisocyanate and mixtures thereof.

Water soluble monomers used to prepare the microcapsule wall of the described compositions, may include the groups consisting of diamines and polyamines. A particularly suitable water soluble monomer is ethylenediamine (EDA).

Surfactants used to prepare the microencapsulated, low-melting pesticidal or herbicidal active ingredient of the described compositions include one or more of a solid, emulsifying or dispersing surfactant. These surfactants can be ionic or nonionic in structure and can be employed as emulsifying agents, wetting agents, dispersing agents, or for other purposes. Suitable surfactants include, but are not limited to, alkyl polyglucosides such as, for example, Agnique® PG 9116 (Cognis, Cincinnati, Ohio), lignosulfonate salts such as, for example, Borresperse NA (Borregaard LignoTech, Bridgewater, N.J.) or Polyfon® F (MeadWestvaco, Richmond, Va.), polyvinyl alcohols such as, for example, Selvol® 205, sucrose esters of fatty acids such as, for example, oleate or caprylate esters of sucrose and sodium dioctylsulphosuccinate which is found in Geropon® SDS (Rhodia, Cranberry, N.J.).

### V. STABILITY PROPERTIES

As used herein, the term “stable composition,” which may include solid or liquid compositions or concentrates, refers to compositions that are stable physically and/or chemically for defined periods of time to the environments in which they are produced, transported and/or stored. Aspects of “stable composition” include, but are not limited to: physical stability at temperatures that range from about 0° C. to about 50° C., homogeneity, pourability, liquids that do not exhibit appreciable sedimentation or Ostwald ripening of the dispersed particles, compositions that form little or no precipitated solids or exhibit phase separations, compositions that readily disperse when poured into a spray tank of water and retain their biological efficacy when applied, for example, by spray application to target pests. In some embodiments, the compositions form stable, homogeneous concentrates that do not exhibit crystallization and/or exhibit very little change in viscosity under the storage conditions.

In some embodiments, the described aqueous herbicidal concentrates are stable at temperatures of greater than or equal to about 40° C. for a period of at least 1, 2, 4, 6, 8, 10, 12, 14, 16 or 18 weeks. In some embodiments, the compositions do not exhibit or do not significantly exhibit separation or precipitation (or crystallization) of any of the components at low temperatures.

In some embodiments, the described aqueous herbicidal concentrates remain as homogeneous concentrates after subjecting them to freeze/thaw (F/T) conditions for at least about 2 weeks where the temperature is cycled from about −10° C. to about 40° C. every 24 hours.

In some embodiments, the described solid pesticidal compositions containing a low-melting active ingredient show good stability to the high temperature drying conditions they are subjected to during preparation as they readily disperse when poured into a spray tank of water and retain their biological efficacy when applied, for example, by spray application to target pests.

### VI. METHODS OF PREPARATION

An additional embodiment concerns a method of preparing the solid pesticidal composition which may consist of a water dispersible powder or a water dispersible granule. Water dispersible granule formulations can be produced using one or more of the following processing methods: (1) pan or drum granulation, (2) mixing agglomeration, (3) extrusion granulation, (4) fluid bed granulation or (5) spray drying granulation. The physico-chemical properties of the active ingredient and additives are important to consider when choosing a process to use. G. A. Bell and D. A. Knowles in, “Chemistry and Technology of Agrochemical Formulations,” D. A. Knowles, editor, (Kluwer Academic Publishers, 1998), pages 41-114, describe the types of granules used in agricultural chemical formulations and provide many references to the production of these solid formulations. Powder formulations can be produced by vacuum drying, rotary evaporator drying, spray drying, drum drying or other processing methods that are well known to those of ordinary skill in the art. In any of the processing methods described herein, optional inert ingredients may be added to the composition before, during or after processing to improve the processing or to improve the final quality or stability of the water dispersible granule or the water dispersible powder. These optional inert ingredients may include, but are not limited to, flowability additives and anti-caking agents such as, for example, hydrophilic precipitated silicas, hydrophilic fumed silicas and clays, anti-foaming agents, wetting agents, binders, dispersing agents, solid diluents and carriers.

An example of a method of preparing the solid pesticidal composition described herein comprises:

(1) mixing all water soluble or water dispersible inert ingredients, including the polymeric stabilizer, in water to form an aqueous phase which is then heated;

(2) mixing the polyisocyanate monomer, and any oil soluble or oil dispersible active and inert ingredients to form a liquid or molten oil phase with added heat to maintain as a liquid phase;

(3) adding the heated oil phase prepared in step (2) to the heated aqueous phase prepared in step (1) under high shear homogenization to provide an emulsion;

(4) forming the polyurea capsule shell by adding an aqueous solution of ethylenediamine monomer to the emulsion prepared in step (3) to provide the microcapsule suspension; and

(5) adding an additional portion of the polymeric stabilizer and any optional inert formulation ingredients to the microcapsule suspension prepared in step (4) and drying the resulting mixture to provide the solid pesticidal composition as either a water dispersible powder or a water dispersible granule. If a water dispersible powder is produced by spray drying, it may be further processed into a water dispersible granule using pan or drum granulation, mixing agglomeration, extrusion granulation or fluid bed granulation.

An additional embodiment concerns preparing the described solid pesticidal compositions to contain at least one additional active ingredient such as, for example, an herbicide, an insecticide, a fungicide, a bactericide or an herbicide safener, by adding such an active ingredient to the aqueous stabilized microcapsule suspension prepared in step 5 of the example method of preparation described herein to provide, after drying, a solid pesticidal composition in the form of a water dispersible powder or a water dispersible granule that contains at least two pesticidal active ingredients. Such a composition would have at least one of the pesticidal active ingredients contained inside the microcapsules and at least one of the active ingredients contained outside of the microcapsules. If a water dispersible powder is produced by spray drying, it may be further processed into a water dispersible granule using pan or drum granulation, mixing agglomeration, extrusion granulation or fluid bed granulation.

In some embodiments, the pesticidal active ingredient contained inside the microcapsules of the described solid compositions is fluoroxypyr-meptyl and the pesticidal active ingredient contained outside of the microcapsules is florasulam.

In some embodiments, the pesticidal active ingredient contained inside the microcapsules of the described solid compositions is fluoroxypyr-meptyl and the pesticidal active ingredient contained outside of the microcapsules is pyroxsulam.

In some embodiments, the pesticidal active ingredient contained inside the microcapsules of the described solid compositions is fluoroxypyr-meptyl and the pesticidal active ingredient contained outside of the microcapsules is the compound of the Formula

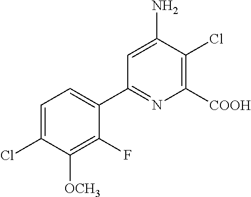 [SMILES: COc1c(Cl)ccc(-c2cc(N)c(Cl)c(C(=O)O)n2)c1F]

and its C₁-C₆ alkyl esters or salt derivatives such as, for example, the methyl ester.

In some embodiments, the pesticidal active ingredient contained inside the microcapsules of the described solid compositions is fluoroxypyr-meptyl and the pesticidal active ingredient contained outside of the microcapsules is the compound of the Formula

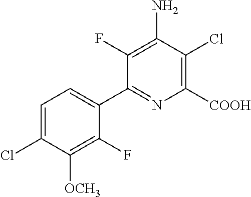 [SMILES: COc1c(Cl)ccc(-c2nc(C(=O)O)c(Cl)c(N)c2F)c1F]

or a C₁-C₁₂ alkyl or C₇-C₁₂ arylalkyl ester or salt derivatives such as, for example, the benzyl ester.

An especially suitable method of preparing the solid pesticidal compositions described herein is to spray dry the aqueous microcapsule suspension containing the additional portion of the polymeric stabilizer and any optional inert formulation ingredients or additional active ingredients prepared in step 5 of the method of preparation described herein to provide the water dispersible powder or the water dispersible granule described herein. If the water dispersible powder is produced by spray drying, it may be further processed into the water dispersible granule using pan or drum granulation, mixing agglomeration, extrusion granulation or fluid bed granulation.

### VII. ADDITIONAL PESTICIDE COMPONENTS

The solid pesticidal compositions or the liquid herbicidal concentrates described herein may be applied in conjunction with one or more other pesticides to control a wider variety of undesirable pests. When used in conjunction with these other pesticides, the presently claimed solid pesticidal compositions or the liquid herbicidal concentrates can be formulated with the other pesticide or pesticides, tank mixed with the other pesticide or pesticides or applied sequentially with the other pesticide or pesticides. In addition to the compositions and uses set forth above, the compositions described herein may be used in combination with one or more additional compatible ingredients. Other additional compatible ingredients may include, for example, one or more agrochemical active ingredients, surfactants, dyes, fertilizers, growth regulators and pheromones and any other additional ingredients providing functional utility, such as, for example, stabilizers, fragrants and dispersants.

It is usually desirable to utilize one or more surface-active agents (i.e., surfactants) with the compositions described herein when they are combined with or used in conjunction with additional compatible ingredients as described herein. Such surface-active agents are advantageously employed in both solid and liquid compositions, especially those designed to be diluted with carrier before application. The surface-active agents can be anionic, cationic or nonionic in character and can be employed as emulsifying agents, wetting agents, suspending agents, or for other purposes. Surfactants conventionally used in the art of formulation and which may also be used in the present formulations are described, inter alia, in “McCutcheon's Detergents and Emulsifiers Annual”, MC Publishing Corp., Ridgewood, N.J., 1998 and in “Encyclopedia of Surfactants”, Vol. I-III, Chemical publishing Co., New York, 1980-81. Typical surface-active agents include salts of alkyl sulfates, such as diethanolammonium lauryl sulfate; alkylarylsulfonate salts, such as calcium dodecyl-benzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkylnaphthalene-sulfonate salts, such as sodium dibutylnaphthalenesulfonate; dialkyl esters of sulfosuccinate salts, such as sodium di(2-ethylhexyl) sulfosuccinate; lignosulfonate salts, such as sodium lignosulfonate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, particularly methyl esters.

Oftentimes, some of these materials, such as vegetable or seed oils and their esters, can be used interchangeably as an agricultural adjuvant, as a liquid carrier or as a surface active agent.

The solid pesticidal compositions described herein may, optionally, be combined or blended with other solid compositions containing different pesticidal active ingredients to form a composition containing, for example, a physically uniform blend of granules or a physically uniform blend of powders. This blend of solid compositions may be used to control a broader spectrum of undesirable pests in crop and non-crop environments.

### VIII. METHODS OF CONTROLLING UNDESIRABLE VEGETATION

Another embodiment concerns a method of controlling undesirable vegetation, fungal pathogens or insects which comprises adding the described solid pesticidal compositions or the liquid herbicidal compositions to a carrier such as water and using the resulting water solution containing the dispersed pesticidal active ingredient for spray application to control undesirable vegetation, fungal pathogens or insects in crop or non-crop environments. In this aspect, a pesticidally effective amount of the aqueous spray mixture derived from the solid pesticidal composition or the liquid herbicidal composition is applied, for example, to an area of soil or targeted plant foliage to provide suitable control of the undesirable plant pests.

The solid pesticidal compositions or liquid herbicidal concentrates described herein can additionally be employed to control undesirable vegetation in many crops that have been made tolerant to or resistant to them or to other herbicides by genetic manipulation or by mutation and selection. The described compositions can, further, be used in conjunction with glyphosate, glufosinate, dicamba, imidazolinones or 2,4-D on glyphosate-tolerant, glufosinate-tolerant, dicamba-tolerant, imidazolinone-tolerant or 2,4-D-tolerant crops. It is generally preferred to use the described compositions in combination with herbicides that are selective for the crop being treated and which complement the spectrum of weeds controlled by these compounds at the application rate employed. It is further generally preferred to apply described compositions and other complementary herbicides at the same time, either as a combination formulation or as a tank mix. Similarly the described compositions can be used in conjunction with acetolactate synthase inhibitors on acetolactate synthase inhibitor tolerant crops.

### IX. OTHER ASPECTS

In an exemplary procedure for preparing the described solid pesticidal compositions a water phase was prepared by mixing together the water soluble ingredients including, but not limited to, the solid, water soluble polymers or surfactants and, optionally, other inert ingredients in water. An oil phase was prepared by mixing together the oil soluble ingredients including, but not limited to, oil soluble surfactants, oil soluble diisocyanate or polyisocyanate monomers and oil soluble active ingredients with heat applied to maintain the oil phase in a liquid state. The heated oil phase was slowly added into the heated aqueous phase under high shear homogenization until the desired emulsion droplet size was obtained. The mixture was then treated with the water soluble diamine or polyamine monomer to form the microcapsule and then an additional portion of the polymeric stabilizer was added and the resulting aqueous capsule suspension was dried to provide the described solid pesticidal composition as a water dispersible powder or a water dispersible granule. The microencapsulated, low-melting pesticidal active ingredient of the described compositions may be prepared in either a batch process or a continuous process.

An example of a stable, high-load, solid pesticidal composition containing a low-melting active ingredient comprises:
1) a microcapsule consisting of (a) a water insoluble, thin-wall polyurea shell prepared by an interfacial polycondensation reaction between ethylenediamine and PAPI® 27 polyisocyanate and (b) a core comprising fluoroxypyr-meptyl wherein
   (i) the ratio of amino moieties to isocyanate moieties is about 1:1,
   (ii) the shell has a thickness of greater than about 10 nanometers (nm) and less than about 60 nm,
   (iii) the average microcapsule size is from about 1 micrometer (μm) to about 25 μm, and
   (iv) the weight ratio of the core to the polyurea shell is from about 2 to about 165;
2) a solid, water soluble polymeric stabilizer comprising, with respect to the total composition, from about 5 g/kg to about 250 g/kg of a polyvinyl alcohol;
3) a solid, emulsifying or dispersing surfactant comprising, with respect to the total composition, from about 5 g/kg to about 300 g/kg of an alkyl polyglycoside;
4) an inert formulation ingredient comprising, with respect to the total composition, from about 50 g/kg to about 150 g/kg of Pergopak M; and
5) an inert formulation ingredient comprising, with respect to the total composition, from about 40 g/kg to about 80 g/kg of a sodium lignosulfonate.
wherein the microcapsule, is present in an amount of, with respect to the total composition, from about 300 g/kg to about 900 g/kg, and
wherein the solid pesticidal composition is a water dispersible powder or a water dispersible granule.

Another example of a stable, high-load, solid pesticidal composition containing a low-melting active ingredient comprises:
1) a microcapsule consisting of (a) a water insoluble, thin-wall polyurea shell prepared by an interfacial polycondensation reaction between ethylenediamine and PAPI® 27 polyisocyanate and (b) a core comprising fluoroxypyr-meptyl wherein
   (i) the ratio of amino moieties to isocyanate moieties is about 1:1,
   (ii) the shell has a thickness of greater than about 10 nanometers (nm) and less than about 60 nm,
   (iii) the average microcapsule size is from about 1 micrometer (μm) to about 25 μm, and
   (iv) the weight ratio of the core is from about 2 to about 165;
2) a solid, water soluble polymeric stabilizer comprising, with respect to the total composition, from about 5 g/kg to about 250 g/kg of a polyvinyl alcohol;
3) a solid, emulsifying or dispersing surfactant comprising, with respect to the total composition, from about 5 g/kg to about 300 g/kg of a sodium lignosulfonate;
wherein the microcapsule is present in an amount of, with respect to the total composition, from about 300 g/kg to about 900 g/kg, and
wherein the solid pesticidal composition is a water dispersible powder or a water dispersible granule.

In some embodiments the solid pesticidal composition containing the low-melting active ingredient comprises fluoroxypyr-meptyl.

In some embodiments the solid pesticidal composition containing a low-melting active ingredient comprises benfluralin, trifluralin, pendimethalin or ethalfluralin.

In some embodiments the solid pesticidal composition containing the low-melting active ingredient comprises cyhalofop, clodinafop, dithiopyr, fenoxaprop, fenoxaprop-P, haloxyfop, haloxyfop-P, quizalofop or quizalofop-P, and derivatives or mixtures thereof.

In some embodiments the solid pesticidal composition containing the low-melting active ingredient comprises nitrapyrin, myclobutanil, chlorpyrifos, chlorpyrifos-methyl, or cloquintocet-mexyl.

In one embodiment of the solid compositions described herein,
(a) the water soluble polyamine monomer is a diamine and the oil soluble polyisocyante monomer is a diisocyanate;
(b) the low melting active ingredient is fluoroxypyr-meptyl, benfluralin, trifluralin, ethalfluralin, cyhalofop, clodinafop, dithiopyr, fenoxaprop, fenoxaprop-P, haloxyfop, haloxyfop-P, quizalofop or quizalofop-P, or nitrapyran;
(c) the polyurea shell has a thickness of from about 20 nm to about 40 nm;
(d) the average microcapsule size is from about 1 μm to about 20 μm;
(e) the weight ratio of the core to the polyurea shell is from about 10 to about 85;
(f) the solid, water soluble, polymeric stabilizer is a polyvinyl alcohols or polyvinylpyrrolidones;
(g) the solid, water soluble, polymeric stabilizer is present in an amount, with respect to the total composition, of from about 20 g/kg to about 50 g/kg;
(h) the solid emulsifying or solid dispersing surfactant is an APG surfactant, lignosulfonate salt, a sucrose ester of a fatty acid, or a caprylate ester of sucrose and sodium dioctyl sulphossuccinate; and

the solid emulsifying or solid dispersing surfactant present in an amount, with respect to the total composition, of from about 200 g/kg to about 250 g/kg.

In one embodiment of the aqueous compositions described herein,
(a) the water soluble polyamine monomer is a diamine and the oil soluble polyisocyanate monomer is a diisocyanate;
(b) wherein the low melting active ingredient is benfluralin, ethalfluralin, trifluralin, fluoroxypyr meptyl, or nitrapyrin;
(c) the polyurea shell has a thickness of from about 15 nm to about 45 nm;
(d) the average microcapsule size is from about 15 μm to about 20 μm;
(e) the weight ratio of the core to the polyurea shell is from about 50 to about 110;
(f) the low-melting active ingredient is present in an amount of from about 400 g/L to about 600 g/L;
(g) the solid emulsifying or solid dispersing surfactant is a polyvinyl alcohol;
(h) the solid emulsifying or solid dispersing surfactant is present in an amount, with respect to the total composition, from about 5 g/L to about 15 g/L; and
wherein the core comprises no more than 3% of oil solvent with respect to the total weight of the core.

### X. EXAMPLES

The described embodiments and following examples are for illustrative purposes and are not intended to limit the scope of the claims. Other modifications, uses, or combinations with respect to the compositions described herein will be apparent to a person of ordinary skill in the art without departing from the spirit and scope of the claimed subject matter.

### Example 1

### Preparation of Stable Powders Containing a High-Load of Fluoroxypyr-Meptyl

### Powders A and B:

A high-load, stable, fluoroxypyr-meptyl dry powder formulation was prepared by spray drying a microencapsulated oil-in-water emulsion as described herein. The oil phase of the oil-in-water emulsion was prepared by dissolving 3.440 g of polyisocyanate (PAPI® 27; The Dow Chemical Company, Midland, Mich.) in 67.303 g of molten fluoroxypyr-meptyl technical (melting point about 58° C.) at 70° C. The aqueous phase of the oil-in-water emulsion was prepared by dissolving 17.301 g of a 20 wt % aqueous solution of polyvinyl alcohol (PVA; Selvol® 205; Sekisui Specialty Chemicals America LLC, Dallas, Tex.) and 3.042 g of a 50 wt % solution of an alkylated polyglucoside (APG) solution (Agnique® PG 9116; Cognis, Cincinnati, Ohio) in 60.846 g of deionized (DI) water at 70° C. The oil phase was slowly added into the aqueous phase while mixing with a Silverson high shear mixer for 5-10 minutes at approximately 3000 to 5000 rpm to produce a fine emulsion with suspended oil droplets with a volume average mean diameter (d(0.5)) of about 2.5 microns (μm). The aqueous emulsion contains 50.161 wt % of water, 2.278 wt % of PVA, 1.001 wt % of APG, 44.300 wt % of fluoroxypyr tech, and 2.262 wt % of PAPI 27. Once the desired emulsion size was obtained, 2.736 g of a 30 wt % aqueous solution of ethylenediamine was added dropwise into the mixture over a period of about 2-3 minutes at 70° C. The mixture was then kept at 70° C. for about 1 hour with Silverson mixing to form microcapsules with a capsule wall thickness of about 25 nanometers (nm). The microencapsulated oil droplets were further stabilized by adding an additional 39.744 g of 20 wt % aqueous Selvol® 205 PVA to the microcapsule suspension. An aqueous solution of 0.380 g of 50 wt % APG (Agnique® PG 9116), 5.704 g of Pergopak® M (Albemarle Corp., Baton Rouge, La.), 9.612 g of Polyfon® F (MeadWestvaco, Richmond, Va.) and 233.607 g of DI water was added to the microcapsule suspension. The final aqueous microcapsule suspension containing 22.5 wt % solids in water and maintained at 70° C. was dried in a spray drier (BUCHI 290) at a feed rate of 300 ml/hr and inlet/outlet temperatures of about 135° C./80° C., respectively. The dried powder (Powder A) provided particles with a volume median diameter (d(0.5)) of 4.8 μm upon redispersion in water. Compositions of Powder A and a similarly prepared sample (Powder B), containing built-in adjuvant, are shown in Table 1.

TABLE 1
Composition of High-Load Powders Containing Fluroxypyr-meptyl

| | | Powder B |
|---|---|---|
| | Powder A | (w/built-in |
| Ingredients | (Wt %) | adjuvant¹; Wt %) |
| Fluroxypyr-meptyl (a.i.) | 67.303 | 73.750 |
| PAPI ® 27 | 3.440 | 3.000 |
| Ethylenediamine (EDA) | 0.821 | 0.720 |
| PVA (Celvol ® 205) | 11.409 | 7.000 |
| APG (Agnique ® PG 9116) | 1.711 | 12.000¹ |
| Pergopak ® M | 5.704 | 0.00 |
| Polyfon ® F | 9.612 | 0.00 |
| Morwet ® D425 | 0.000 | 3.540 |

¹The additional amount of Agnique ® PG 9116 used in this sample, as compared to Powder A, serves as the built-in adjuvant.

### Powders C and D:

A high-load, stable, fluoroxypyr-meptyl dry powder formulation was prepared by spray drying a microencapsulated oil-in-water emulsion as described herein. The oil phase of the oil-in-water emulsion was prepared by dissolving 3.452 g of polyisocyanate (PAPI® 27; The Dow Chemical Company, Midland, Mich.) in 67.622 g of molten floroxypyr-meptyl technical (melting point about 58° C.) at 70° C. The aqueous phase of the oil-in-water emulsion was prepared by dissolving 18.5 g of a 20 wt % aqueous solution of polyvinyl alcohol (PVA; Selvol® 205; Sekisui Specialty Chemicals America LLC, Dallas, Tex.) containing 0.1 wt % Proxel® GXL as biocide and 69.667 g of a 35 wt % solution of sodium lignosulfonate (Borresperse Na, Borregaard LignoTech, Sarpsborg, Norway) at 70° C. The oil phase was slowly added into the aqueous phase while mixing with a Silverson high shear mixer for 5-10 minutes at approximately 5000 rpm to produce a fine emulsion with suspended oil droplets with a volume median diameter (d(0.5)) of about 2.5 microns (μm). The aqueous emulsion contains 37.727 wt % of water, 2.323 wt % of PVA, 15.310 wt % of sodium lignosulfonate, 0.012 wt % Proxel GXL, 42.460 wt % of fluoroxypyr tech, and 2.168 wt % of PAPI 27. Once the desired emulsion size was obtained, 2.746 g of a 30 wt % aqueous solution of ethylenediamine was added dropwise into the mixture over a period of about 30 seconds while mixing with the Silversion mixer. The mixture was then kept at 70° C. for about 1 to 2.5 hours depending on batch sizes with Silverson mixing to form microcapsules with a capsule wall thickness of about 25 nanometers (nm). 237.994 g of DI water was added to the microcapsule suspension to produce the final aqueous microcapsule suspension containing 25 wt % solids in water. The microcapsule suspension, maintained at 70° C., was dried in a spray dryer (BUCHI 290) at a feed rate of 300 ml/hr and inlet/outlet temperatures of about 135° C./80° C., respectively. The dried powder (Powder C) provided particles with a volume median diameter (d(0.5)) of about 3-5 μm upon re-dispersion in water.

In a similar manner, another dry powder composition was prepared by adding ammonium sulfate to the microcapsule suspension prepared above prior to feeding it into the spray dryer resulting in the preparation of Powder D (Table 2). Powder D provided particles with a volume median diameter (d(0.5)) of about 3-5 μm upon re-dispersion in water.

The compositions described in Table 2 were also prepared at larger scale by using an in-line homogenizer to create the emulsion and an in-line static mixer for the ethylenediamine addition. The tip speed of the homogenizer (IKA Magic) using a coarse, medium, fine rotor-stator combination was 21-24 meters/second at a liquid flow rate of about 800 g/min. Spray drying was accomplished at the larger scale with a Niro Mobile Minor spray dryer using a liquid feed rate of about 40 grams/minute and inlet/outlet temperatures of 135° C. and 75° C., respectively.

TABLE 2
Composition of High-Load Powders Containing Fluroxypyr-meptyl

| | Powder C | Powder D |
|---|---|---|
| Ingredients | (Wt %) | (Wt %) |
| Fluroxypyr-meptyl (a.i.) | 67.622 | 59.52 |
| PAPI ® 27 | 3.452 | 3.04 |
| Ethylenediamine (EDA) | 0.824 | 0.73 |
| PVA (Selvol ® 205) | 3.7 | 3.26 |
| Borresperse Na | 24.383 | 21.46 |
| Proxel GXL | 0.019 | 0.016 |
| Ammonium Sulfate | 0.000 | 11.98 |

### Example 2

### Preparation of High Load Compositions Containing Benfluralin

### A: Preparation of High Load Aqueous Capsule Suspensions Containing Benfluralin

### Continuous Process:

Using the ingredients and amounts listed in Table 3 an aqueous capsule suspension of benfluralin was prepared. An aqueous phase composed of 1.25 wt % polyvinyl alcohol (Selvol 205) and 8 wt % sodium acetate was prepared and maintained at 80° C. Molten benfluralin technical was combined in-line with a mixture of polyisocyanate (PAPI 27; Dow Chemical) and Aromatic 150ND, to provide an oil phase that was maintained at 80° C. as it was added along with the aqueous phase above in a continuous feed process to a rotor-stator homogenizer (10-15 meters/sec tip speed) to provide the desired 17 micron sized oil droplets (d(0.5)) in the resulting emulsion that was then treated in-line with 10 wt % ethylenediamine in water as it was pumped out of the homogenizer to form the 35 nm polyurea capsule wall of the 17.7 micron sized (d(0.5)) capsules as determined on a Malvern Mastersizer 2000. The mixture was allowed to stir and cool to room temperature to provide Capsule Suspension A. Once Capsule Suspension A had cooled to ambient temperature, aqueous solutions of the rheology modifiers xantham gum (Kelzan S; 3 wt % in water) and smectite clay (Veegum K; 5 wt % in water) were added using an IKA Eurostar Power Cont-Visc mixer with a 1.6″ dispersing blade. Additional water and Proxel GXL were finally added to bring the final concentration of benfluralin in the resulting capsule suspension to 480 g/L (Sample 27). In a similar manner, Sample 28 was also prepared.

TABLE 3
Composition of Aqueous Capsule Suspensions Containing
Benfluralin Prepared by a Continuous Process

| | |
|---|---|
| 27 | 28 |

| Component | g/L | Wgt % | g/L | Wgt % |
|---|---|---|---|---|
| Benfluralin | 480.00 | 41.45 | 480.00 | 41.58 |
| Tech impurities | 20.00 | 1.73 | 20.00 | 1.73 |
| Aromatic 150ND | 5.05 | 0.44 | 55.56 | 4.81 |
| PAPI 27 | 5.07 | 0.44 | 5.59 | 0.48 |
| EDA | 1.22 | 0.11 | 1.34 | 0.12 |
| Celvol 205 | 5.74 | 0.50 | 6.31 | 0.55 |
| Veegum | 2.30 | 0.20 | 2.53 | 0.22 |
| Kelzan S | 0.46 | 0.04 | 0.51 | 0.04 |
| Proxel GXL | 0.09 | 0.01 | 0.10 | 0.01 |
| Na Acetate | 36.73 | 3.17 | 40.40 | 3.50 |
| water | 601.43 | 51.93 | 542.13 | 46.96 |
| total | 1,158.08 | 100.00 | 1154.47 | 100.00 |

### Batch Process:

By using a batch processing method, aqueous capsule suspensions 67, 87 and 95 containing benfluralin were prepared as described.

### Preparation of Sample 87:

A high-load, stable, benfluralin liquid formulation was prepared by microencapsulating an oil-in-water emulsion as described herein. The oil phase of the oil-in-water emulsion was prepared by dissolving 1.5 g of polyisocyanate (PAPI® 27; The Dow Chemical Company, Midland, Mich.) in a mixture of 118.6 g of molten benfluralin technical (melting point about 65° C.) and 29.6 g of Aromatic 150ND at 70° C. The aqueous phase of the oil-in-water emulsion was prepared by dissolving 22 g of sodium acetate (Sigma Aldrich) in 150 g of a 3 wt % aqueous solution of polyvinyl alcohol (PVA; Selvol® 205; Sekisui Specialty Chemicals America LLC, Dallas, Tex.) at 70° C. The aqueous phase was slowly added into the oil phase while mixing with a Silverson high shear mixer for 2-3 minutes at approximately 7500 rpm to produce a fine emulsion with suspended oil droplets with a volume average mean diameter (d(0.5)) of about 18 microns (μm). The aqueous emulsion contains 48.1 wt % of water, 1.3 wt % of PVA, 6.5 wt % sodium acetate, 33.14 wt % of benfluralin tech, and 0.43 wt % of PAPI 27. Once the desired emulsion droplet size was obtained, the emulsion was allowed to cool to room temperature and then 3.6 g of a 10 wt % aqueous solution of ethylenediamine was added dropwise into the mixture over a period of about 1-2 minutes. The mixture was then kept at room temperature (25° C.) for about 1 hour with low shear mixing using an IKA Eurostar Power Cont-Visc mixer to form microcapsules with a capsule wall thickness of about 35 nanometers (nm). The microencapsulated oil droplets were further stabilized by adding an additional 15 g of 5 wt % aqueous Veegum K® and 3 g of 3 wt % aqueous Kelzan 5® to the microcapsule suspension to provide Capsule Suspension 87. Compositions of Capsule Suspension 87 and a similarly prepared sample (Capsule Suspension 67) are shown in Table 4.

### Preparation of Sample 95:

A high-load, stable, benfluralin liquid formulation was prepared by microencapsulating an oil-in-water emulsion as described herein. The oil phase of the oil-in-water emulsion was prepared by dissolving 3.6 g of polyisocyanate (PAPI° 27; The Dow Chemical Company, Midland, Mich.) in a mixture of 118.0 g of molten benfluralin technical (melting point about 65° C.) and 34.0 g of isobutyl salicylate at 70° C. The aqueous phase of the oil-in-water emulsion was prepared by preparing 150 g of a 3 wt % aqueous solution of polyvinyl alcohol (PVA; Selvol® 205; Sekisui Specialty Chemicals America LLC, Dallas, Tex.) at 70° C. The aqueous phase was slowly added into the oil phase while mixing with a Silverson high shear mixer for 2-3 minutes at approximately 8500 to 9500 rpm to produce a fine emulsion with suspended oil droplets with a volume average mean diameter (d(0.5)) of about 8 microns (μm). Once the desired emulsion droplet size was obtained, the emulsion was allowed to cool to room temperature and then 7.6 g of a 10 wt % aqueous solution of ethylenediamine was added dropwise into the mixture over a period of about 1-2 minutes. Next, 50 g of a 30 wt % aqueous solution of sodium chloride was added dropwise into mixture over period of 2-3 minutes. The mixture was then kept at room temperature (25° C.) for about 1 hour with low shear mixing with IKA Eurostar Power Cont-Visc mixer to form microcapsules with a capsule wall thickness of about 35 nanometers (nm). The microencapsulated oil droplets were further stabilized by adding an additional 15 g of 5 wt % aqueous Veegum K® and 3 g of 3 wt % aqueous Kelzan 5° to the microcapsule suspension to provide Capsule Suspension 95. The composition of Capsule Suspension 95 is shown in Table 4 and the dimensions of microcapsules contained in samples 67, 87 and 95 are shown in Table 5.

TABLE 4
Wt % Composition of High-Load Capsule Suspensions
Containing Benfluralin Prepared by a Batch Process

| | Capsule Suspension ID | | |
|---|---|---|---|
| Component | 87 | 67 | 95 |
| Benfluralin | 33.14 | 33.87 | 29.74 |
| Tech impurities | 1.38 | 1.43 | 1.23 |
| Aromatic 150ND | 8.63 | 8.81 | 0 |
| isobutyl salicylate | 0.00 | 0 | 8.92 |
| PAPI 27 | 0.43 | 0.68 | 0.94 |
| EDA | 0.10 | 1.62 | 1.99 |
| Celvol 205 | 1.31 | 1.34 | 1.18 |
| Veegum | 0.22 | 0.22 | 0.2 |
| Kelzan S | 0.03 | 0 | 0.02 |
| NaAcetate | 6.54 | 0 | 0 |
| Sodium chloride | 0.00 | 4.46 | 3.94 |
| Proxel GXL | 0.11 | 0.01 | 0.01 |
| water | 48.12 | 47.55 | 51.83 |

TABLE 5
Dimensions of Aqueous Microcapsules Containing
Benfluralin Prepared by Batch Processing Method

| Sample | Capsule size (μm) | Wall Thickness (nm) |
|---|---|---|
| 67 | 12.1 | 35 |
| 87 | 17.6 | 35 |
| 95 | 8.4 | 35 |

### Storage Stability Testing of Capsule Suspensions Containing Benfluralin:

The storage stability of benfluralin capsule suspension samples 67, 87 and 95 was assessed by subjecting them to freeze/thaw (F/T) conditions for 2 weeks where the temperature was cycled from about −10° C. to about 40° C. every 24 hours. After storage (2 wk F/T), the sample stability was evaluated by measuring the particle size distribution and comparing it to the initial values as shown in Table 6. As shown in Table 7, benfluralin capsule suspension sample 27 (prepared by a continuous process) was stored at a number of different temperature conditions and showed good stability. Table 7A shows the weight % of solids obtained from samples 27 and 28 that were collected after passing them through Wet Sieve-No. 200 (75 micron).

TABLE 6
Storage Stability Testing of Aqueous Microcapsules Prepared by
Batch Processing Method by Monitoring Particle Size Changes

| | Particle Size (μm) | | |
|---|---|---|---|
| | Storage | | |
| Sample | Conditions | d(0.5) | d(0.9) |
| 67 | initial | 12.1 | 19 |
| | 2 wk F/T | 18.3 | 44.9 |
| 87 | initial | 17.6 | 27.2 |
| | 2 wk F/T | 17.7 | 27.3 |
| 95 | initial | 8.4 | 14.2 |
| | 2 wk F/T | 13.6 | 55.1 |

TABLE 7
Storage Stability Testing of Aqueous Capsule Suspension
Sample 27 and Sample 28 Prepared by a Continuous Processing
Method by Monitoring Particle Size Changes

| Particle Size (μm) | |
|---|---|
| 27 | 28 |

| Storage Conditions | d(0.5) | d(0.9) | d(0.5) | d(0.9) |
|---|---|---|---|---|
| initial | 17.7 | 27.2 | 17.3 | 26.7 |
| 2 wk 40° C. | 17.8 | 30.2 | 16.9 | 26.1 |
| 2 wk F/T | 18.3 | 31.4 | 20.3 | 43.8 |
| 4 wk 40° C. | 17.6 | 27.1 | 16.9 | 26.1 |
| 8 wk 40° C. | 17.6 | 27.1 | 17 | 26.2 |
| 18 wk 40° C. | 17.4 | 26.9 | 17 | 26.3 |

TABLE 7A
Wt % of Solids from 27 and 28 that were Collected
in Wet Sieve-No. 200 (75 micron)

| Storage Conditions | 27 | 28 |
|---|---|---|
| 2 wk 40° C. | 0.000% | 0.000% |
| 2 wk F/T | 0.010% | 1.070% |
| 4 wk 40° C. | 0.010% | 0.010% |
| 8 wk 40° C. | 0.016% | 0.020% |

### B: Preparation of Stable Spray Dried Powders Containing Benfluralin

The following procedure was used to prepare the compositions listed in Table 8. A sample of Capsule Suspension A (benfluralin CS) was added to a 150 ml glass beaker, followed by water, Celvol 205, Borresperse Na, and the processing agent (Pergopak M or Morwet D-425, where applicable). Each sample, containing about 25 wt % of solids, was prepared using an IKA Eurostar 6000 mixer with 1″ dispersing blade revolving at 1200 rpm. Each solution was allowed to thoroughly mix (5-10 min) before being spray dried. A Buchi B-290 spray dryer was set up to run in closed cycle mode in which positive pressure was used to push nitrogen gas, rather than air, through the system instead of using negative pressure to draw the nitrogen gas through the system. Furthermore, nitrogen gas was introduced into the system through the spray nozzle as the atomization gas and was piped into the intake of the blower to yield a total oxygen content of about 3.8% when the system was fully operational. A peristaltic pump was used to deliver the liquid benfluralin CS sample to the spray dryer. The inlet/outlet temperatures for the spray dryer were 100° C./40° C. for sample 1A and 105-110° C./46-52° C. for samples 1B-1E. Once each sample had been spray dried, the dried powder was collected and the particle size was measured using a Malvern Master Sizer 2000. The particle sizes of the spray dried samples can be seen below in Table 9 along with the particle size of the benfluralin CS composition that was used to prepare each sample. The data in Table 9 shows that each spray dried powder, upon addition to water, provides particles that are of a similar size to those of the starting capsule suspension.

TABLE 8
Composition of Spray Dried Powders Containing Benfluralin

| Component | 1A | 1B | 1C | 1D | 1E |
|---|---|---|---|---|---|
| Benfluralin | 67.00% | 72.11% | 79.29% | 67.68% | 67.23% |
| Tech | | | | | |
| Aromatic | 7.45% | 8.02% | 8.82% | 7.53% | 7.48% |
| 150 ND | | | | | |
| PAPI 27 | 0.75% | 0.81% | 0.89% | 0.76% | 0.75% |
| EDA | 0.17% | 0.19% | 0.21% | 0.18% | 0.17% |
| Celvol 205 | 13.27% | 6.33% | 3.48% | 12.45% | 9.91% |
| Sodium | 5.41% | 5.82% | 6.40% | 5.47% | 5.43% |
| Acetate | | | | | |
| Proxel GXL | 0.08% | 0.04% | 0.03% | 0.07% | 0.06% |
| Agrimer 30 | 0.00% | 0.00% | 0.00% | 0.00% | 0.00% |
| Borresperse | 5.87% | 6.69% | 0.88% | 0.00% | 2.92% |
| NA | | | | | |
| Morwet | 0.00% | 0.00% | 0.00% | 5.87% | 0.00% |
| D-425 | | | | | |
| Pergopak M | 0.00% | 0.00% | 0.00% | 0.00% | 6.05% |
| Total | 100.00% | 100.00% | 100.00% | 100.00% | 100.00% |

TABLE 9
Particle Size Analysis of Spray Dried Powders Containing
Benfluralin after Re-dispersion in Water

Particle Size (μm)

| Sample ID | d(0.5) | d(0.9) |
|---|---|---|
| Capsule Suspension A | 17.2 | 26.6 |
| 1A | 17 | 27.5 |
| 1B | 18.5 | 37.2 |
| 1C | 17.2 | 29.2 |
| 1D | 16.9 | 27.7 |
| 1E | 17.4 | 35.2 |

### Calculations for Determining Microcapsule Shell Wall Thickness

Microcapsule wall thickness may be determined using methodology know to those of ordinary skill in the art. In one embodiment, shell wall thickness is determined as set forth below. The calculation of the amounts of capsule wall components needed to achieve a target wall thickness was based on the geometric formula relating the volume of a sphere to its radius. If a core-shell morphology is assumed, with the core comprised of the non wall-forming, water insoluble components (herbicide and herbicide safener) and the shell wall made up of the polymerizable materials (oil and water soluble monomers), then equation (1) holds, relating the ratio of the volume of the core (V_{C}) and the volume of the core, plus the volume of the shell (V_{S}) to their respective radii, where r_{S} is radius of the capsule including the shell and lₛ is thickness of the shell.

$$\frac{{V}_{c} + {V}_{s}}{{V}_{c}} = {( \frac{{r}_{s}}{{r}_{s} - {l}_{s}} )}^{3} \qquad ( 1 )$$

Solving equation (1) for the volume of the shell yields:

$${V}_{S} = {V}_{C} ( {( \frac{{r}_{S}}{{r}_{S} - {l}_{S}} )}^{3} - 1 ) \qquad ( 2 )$$

Substituting masses (mᵢ) and densities (dᵢ) for their respective volumes (m_{S}/d_{S}=V_{S} and m_{C}/d_{C}=V_{C}, where the subscript s or c refers to the shell or core, respectively) and solving for the mass of the shell gives:

$${m}_{S} = {m}_{C} \frac{{d}_{S}}{{d}_{C}} ( {( \frac{{r}_{S}}{{r}_{S} - {l}_{S}} )}^{3} - 1 ) \qquad ( 3 )$$

In order to simplify the calculation and directly use the respective weights of the capsule core and shell components the approximation that the density ratio dₛ/d_{c} is approximately equal to one was made yielding equation (4).

$${m}_{S} \approx {m}_{C} ( {( \frac{{r}_{S}}{{r}_{S} - {l}_{S}} )}^{3} - 1 ) \qquad ( 4 )$$

Making the substitutions m_{C}=m_{O}−m_{OSM}, m_{S}=m_{O}+(f_{WSM/OSM})m_{OSM}−m_{C}, and f_{WSM/OSM}=m_{WSM}/m_{OSM} (the ratio of water soluble monomer to oil soluble monomer), where m_{O} is the total mass of the oil components (herbicide, herbicide safener and oil-soluble monomer), m_{OSM} is the mass of the oil-soluble monomer, and m_{WSM} is the mass of the water-soluble monomer, and solving for m_{OSM} yields:

$${m}_{OSM} = \frac{{m}_{O} ( {( \frac{{r}_{S}}{{r}_{S} - {l}_{S}} )}^{3} - 1 )}{{f}_{WSM / OSM} + {( \frac{{r}_{S}}{{r}_{S} - {l}_{S}} )}^{3}} \qquad ( 5 )$$

For the determination of m_{OSM}, the entire quantity of m_{WSM} was used in the calculation as a convention.

### Example 2

### Use of the Described Compositions for Weed Control

### Use of Spray Dried Powders Containing Fluoroxypyr-Meptyl for Weed Control

### Postemergence Greenhouse Trial Methods:

A peat based potting soil, Metro-mix 360, (produced by Sun Gro Horticulture Canada CM Ltd) was used as the soil media for this test. Metro-mix 360 is a growing medium consisting of Canadian sphagnum peat moss, coarse perlite, bark ash, starter nutrient charge (with gypsum) and slow release nitrogen and dolomitic limestone. Several seeds of each species were planted in 10 cm square pots and top watered twice daily. Plant material was propagated in greenhouse zone E2 at a constant temperature of 18 to 20° C. and 50 to 60% relative humidity. Natural light was supplemented with 1000-watt metal halide overhead lamps with an average illumination of 500 microeinsteins per square meter per second (μE m⁻² s⁻¹) photosynthetic active radiation (PAR). Day length was 16 hours. Plant material was top-watered prior to treatment and sub-irrigated after treatment. Treatments were applied with a track sprayer manufactured by Allen Machine Works and located in building 306, room E1-483. The sprayer utilized an 8003E spray nozzle, spray pressure of 262 kPa pressure and speed of 2.0 mph to deliver 187 L/Ha. The nozzle height was 46 cm above the plant canopy. The growth stage of the various weed species ranged from 2 to 6 leaf and is listed below by species Application rates were 0, 8.8, 17.5, 35, 70 and 140 g ae/ha. Treatments were replicated 3 times. Plants were returned to the greenhouse after treatment and sub-watered throughout the duration of the experiment. Plant material was fertilized twice weekly with Hoagland's fertilizer solution that is readily available in the greenhouses. Percent visual injury assessments were made on a scale of 0 to 100% as compared to the untreated control plants (where 0 is equal to no injury and 100 is equal to complete death of the plant.

TABLE 10
Information Table for the Plant Species
Tested with the Described Compositions.

| | | Bayer | Growth Stage at |
|---|---|---|---|
| Common Name | Scientific Name | Code | application |
| Galium | Galium aparine | GALAP | 3 to 4 leaf |
| Common | Stellaria media | STEME | 4 to 6 leaf |
| chickweed | | | |
| Wild | Polygonum convolvulus | POLCO | 2 to 4 leaf |
| buckwheat | | | |
| Kochia | Kochia scoparia | KCHSC | 2 to 4 leaf |
| Soybeans | Glycine max | GLXMA | 1 to 2 trifoliate |

TABLE 11
Percent Weed Control Using an Aqueous Spray Solution Prepared
from Powder A Alone and With Added Tank-mix Adjuvant Agral 90 -
21 days After Application

| | | Rate | % | % | % | |
|---|---|---|---|---|---|---|
| Sample | | (g | Control | Control | Control | % Control |
| Tested | Agral 90¹ | ae/ha) | STEME | GALAP | POLCO | GLXMA |
| Powder A | None | 8.8 | 25 | 23 | NT² | 1 |
| Powder A | None | 17.5 | 18 | 30 | 25 | 10 |
| Powder A | None | 35 | 20 | 52 | 73 | 5 |
| Powder A | None | 70 | 45 | 75 | 88 | 43 |
| Powder A | None | 140 | 90 | NT² | NT² | 63 |
| Powder A | 0.25% | 8.8 | 47 | 43 | NT | 5 |
| Powder A | 0.25% | 17.5 | 91 | 82 | 100 | 43 |
| Powder A | 0.25% | 35 | 93 | 94 | 100 | 73 |
| Powder A | 0.25% | 70 | 98 | 99 | 100 | 83 |
| Powder A | 0.25% | 140 | 100 | NT² | NT² | 97 |

¹Agral 90 is a non-ionic surfactant adjuvant available from Norac Concepts Inc.
²NT—Not Tested

TABLE 12
Percent Weed Control Using an Aqueous Spray Solution Prepared
from Powder B Alone and With Added Tank-mix Adjuvant Agral 90 -
21 days After Application

| | | Rate | % | % | % | |
|---|---|---|---|---|---|---|
| Sample | | (g | Control | Control | Control | % Control |
| Tested | Agral 90¹ | ae/ha) | STEME | GALAP | POLCO | KCHSC |
| Powder B | None | 8.8 | 10 | 72 | 40 | 50 |
| Powder B | None | 17.5 | 15 | 83 | 67 | 62 |
| Powder B | None | 35 | 22 | 91 | 78 | 69 |
| Powder B | None | 70 | 46 | 96 | 83 | 78 |
| Powder B | None | 140 | 76 | 100 | 98 | 92 |
| Powder B | 0.25% | 8.8 | 12 | 75 | 63 | 60 |
| Powder B | 0.25% | 17.5 | 18 | 86 | 72 | 70 |
| Powder B | 0.25% | 35 | 41 | 91 | 83 | 82 |
| Powder B | 0.25% | 70 | 67 | 97 | 93 | 90 |
| Powder B | 0.25% | 140 | 84 | 100 | 98 | 97 |

¹Agral 90 is a non-ionic surfactant adjuvant available from Norac Concepts Inc.

### Use of Aqueous Capsule Suspensions Containing Benfluralin for Weed Control

### Preplant Incorporated Greenhouse Trial Methods:

### Soil Treatment:

Four-5 inch pots containing “Mooresville” sandy Loam soil were used for each treatment. A hand held sprayer (nozzle: 8003E) was used to apply the spray solutions to 18 kilograms of soil in a cement mixer at a spray volume of 300 milliliters (mLs) of solution per treatment.

### Planting:

Once treated, the soil was placed in 16-5 inch pots and the soil tamped down. A sample of treated soil was reserved as a cover soil following planting. Seeds were counted or measured by seed scoops into vials before treatment. The seeds were planted into the treated soil and covered with an appropriate amount of treated cover soil. The pots were kept in a greenhouse maintained at 18° C., were top-watered as needed to maintain acceptable moisture levels and were evaluated at the indicated intervals after application. Percent visual injury assessments were made on a scale of 0 to 100% as compared to the untreated control plants (where 0 is equal to no injury and 100 is equal to complete death of the plant).

### Plant Species: (Some Co-Planted in a Single Pot)

| Common Name | Bayer Code |
|---|---|
| Redroot pigweed/perennial ryegrass | AMARE/LOLPE |
| Crabgrass | DIGSA |
| Field violets/Lambsquarters | VIOAR/CHEAL |

### Herbicide Test Results:

Based on results from the greenhouse study shown in Table 13, it was observed that the 17 micron/35 nm (capsule size/wall thickness) capsule (sample 87) performed nearly equivalent to the EC (EF-1533) formulation of benfluralin at a use rate of 1440 g ai/ha. Comparing both the biological data (Table 13) and the physical storage stability data (Table 6), it can be seen that Sample 87 (35 nm capsule wall thickness; 17.6 micron median capsule size) was the better performing composition of the test samples and was comparable biologically to the EC formulation of benfluralin (EF-1533).

TABLE 13
Percent Weed Control Using Aqueous Capsule Suspensions Containing
Benfluralin - Spray Applied at 1440 g/ha as a Preplant Incorporated
Treatment - 21 days After Application

| Sample | % Control | % Control | % Control | % Control |
|---|---|---|---|---|
| Tested | AMARE | LOLPE | DIGSA | CHEAL |
| EF-1533 (EC)¹ | 89 | 94 | 100 | 97 |
| 87 | 88 | 96 | 99 | 97 |
| 67 | 68 | 66 | 93 | 86 |
| 95 | 69 | 89 | 86 | 96 |

¹EF-1533 is a commercial EC formulation containing 180 g/L of benfluralin (not encapsulated).

What is claimed:

1. A stable solid pesticidal composition comprising:
1) a microcapsule consisting of (a) a water insoluble, thin-wall polyurea shell prepared by an interfacial polycondensation reaction between a water soluble polyamine monomer and an oil soluble polyisocyanate monomer and (b) a core comprising a low melting active ingredient, wherein
(i) the ratio of amino moieties to isocyanate moieties is about 1:1;
(ii) the polyurea shell has a thickness of greater than about 10 nm and less than about 60 nm;
(iii) the average microcapsule size is from about 1 nm to about 25 nm;
(iv) the weight ratio of the core to the polyurea shell is from about 2 to about 165; and
(v) the microcapsule is present in an amount, with respect to the total composition, from about 300 g/kg to about 900 g/kg;
2) a solid, water soluble, polymeric stabilizer present in an amount, with respect to the total composition, of from about 5 g/kg to about 250 g/kg; and
3) a solid emulsifying or solid dispersing surfactant present in an amount, with respect to the total composition, from about 5 g/kg to about 300 g/kg.

2. The composition of claim 1, wherein the water soluble polyamine monomer is a diamine and the oil soluble polyisocyante monomer is a diisocyanate.

3. The composition of claim 1, wherein the low melting active ingredient is fluoroxypyr-meptyl, benfluralin, trifluralin, ethalfluralin, cyhalofop, cyhalofop-butyl, clodinafop, dithiopyr, fenoxaprop, fenoxaprop-P, haloxyfop, haloxyfop-P, quizalofop or quizalofop-P, or nitrapyran.

4. The composition of claim 1, wherein the polyurea shell has a thickness of from about 20 nm to about 40 nm.

5. The composition of claim 1, wherein the average microcapsule size is from about 1 μm to about 20 μm.

6. The composition of claim 1, wherein the weight ratio of the core to the polyurea shell is from about 10 to about 85.

7. The composition of claim 1, wherein the solid, water soluble, polymeric stabilizer is a polyvinyl alcohols or polyvinylpyrrolidones.

8. The composition of claim 1, wherein the solid, water soluble, polymeric stabilizer is present in an amount, with respect to the total composition, of from about 20 g/kg to about 50 g/kg.

9. The composition of claim 1, wherein the solid emulsifying or solid dispersing surfactant is an APG surfactant, lignosulfonate salt, a sucrose ester of a fatty acid, or a caprylate ester of sucrose and sodium dioctyl sulphossuccinate.

10. The composition of claim 1, wherein the solid emulsifying or solid dispersing surfactant present in an amount, with respect to the total composition, of from about 200 g/kg to about 250 g/kg.

11. The composition of claim 1, wherein
(a) the water soluble polyamine monomer is a diamine and the oil soluble polyisocyante monomer is a diisocyanate;
(b) the low melting active ingredient is fluoroxypyr-meptyl, benfluralin, trifluralin, ethalfluralin, cyhalofop, cyhalofop-butyl, clodinafop, dithiopyr, fenoxaprop, fenoxaprop-P, haloxyfop, haloxyfop-P, quizalofop or quizalofop-P, or nitrapyran;
(c) the polyurea shell has a thickness of from about 20 nm to about 40 nm;
(d) the average microcapsule size is from about 1 μm to about 20 μm;
(e) the weight ratio of the core to the polyurea shell is from about 10 to about 85;
(f) the solid, water soluble, polymeric stabilizer is a polyvinyl alcohols or polyvinylpyrrolidones;
(g) the solid, water soluble, polymeric stabilizer is present in an amount, with respect to the total composition, of from about 20 g/kg to about 50 g/kg;
(h) the solid emulsifying or solid dispersing surfactant is an APG surfactant, lignosulfonate salt, a sucrose ester of a fatty acid, or a caprylate ester of sucrose and sodium dioctyl sulphossuccinate; and
(i) the solid emulsifying or solid dispersing surfactant present in an amount, with respect to the total composition, of from about 200 g/kg to about 250 g/kg.

12. The composition of claim 1, wherein the composition further comprises one or more additional inert ingredients.

13. The composition of claim 1, wherein the composition further comprises one or more additional active ingredients.

14. The composition of claim 13, wherein the one or more additional active ingredients is pyroxsulam, florasulam, cloquintocent mexyl, a compound of the formula (I) or a C₁-C₆ alkyl ester thereof; 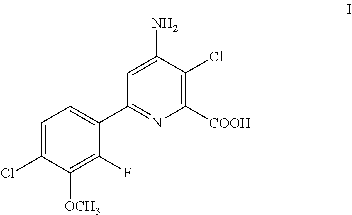 [SMILES: COc1c(Cl)ccc(-c2cc(N)c(Cl)c(C(=O)O)n2)c1F]
or a compound of formula (II) or a or a C₁-C₁₂ alkyl or C₇-C₁₂ arylalkyl ester thereof.

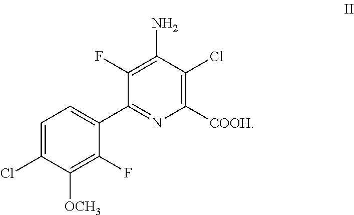 [SMILES: COc1c(Cl)ccc(-c2nc(C(=O)O)c(Cl)c(N)c2F)c1F]

15. A stable aqueous pesticidal composition comprising:
1) a microcapsule consisting of (a) a water insoluble, thin-wall polyurea shell prepared by an interfacial polycondensation reaction between a water soluble polyamine monomer and an oil soluble polyisocyanate monomer and (b) a core comprising a low melting active ingredient, wherein
(i) the ratio of amino moieties to isocyanate moieties is about 1:1;
(ii) the polyurea shell has a thickness of greater than about 20 nm and less than about 75 nm;
(iii) the average microcapsule size is from about 10 μm to about 25 μm;
(iv) the weight ratio of the core to the polyurea shell is from about 2 to about 165;
(v) the low-melting active ingredient is present in an amount of from about 200 g/L to about 750 g/L;
(vi) the core comprises no more than 5% of oil solvent with respect to the total weight of the core; and
2) a solid emulsifying or solid dispersing surfactant present in an amount, with respect to the total composition, of from about 5 g/L to about 150 g/L.

16. The composition of claim 15, wherein the water soluble polyamine monomer is a diamine and the oil soluble polyisocyanate monomer is a diisocyanate.

17. The composition of claim 15, wherein the low melting active ingredient is benfluralin, ethalfluralin, trifluralin, fluoroxypyr meptyl, or nitrapyrin.

18. The composition of claim 15, wherein the polyurea shell has a thickness of from about 15 nm to about 45 nm.

19. The composition of claim 15, wherein the average microcapsule size is from about 15 μm to about 20 μm.

20. The composition of claim 15, wherein the weight ratio of the core to the polyurea shell is from about 50 to about 110.

21. The composition of claim 15, wherein the low-melting active ingredient is present in an amount of from about 400 g/L to about 600 g/L.

22. The composition of claim 15, wherein the solid emulsifying or solid dispersing surfactant is a polyvinyl alcohol.

23. The composition of claim 15, wherein the solid emulsifying or solid dispersing surfactant is present in an amount, with respect to the total composition, of from about 5 g/L to about 15 g/L.

24. The composition of claim 15, wherein the core comprises no more than 3% of oil solvent with respect to the total weight of the core.

25. The composition of claim 15, wherein
(a) the water soluble polyamine monomer is a diamine and the oil soluble polyisocyanate monomer is a diisocyanate;
(b) wherein the low melting active ingredient is benfluralin, ethalfluralin, trifluralin, fluoroxypyr meptyl, or nitrapyrin;
(c) the polyurea shell has a thickness of from about 15 nm to about 45 nm;
(d) the average microcapsule size is from about 15 μm to about 20 μm;
(e) the weight ratio of the core to the polyurea shell is from about 50 to about 110;
(f) the low-melting active ingredient is present in an amount of from about 400 g/L to about 600 g/L;
(g) the solid emulsifying or solid dispersing surfactant is a polyvinyl alcohol;
(h) the solid emulsifying or solid dispersing surfactant is present in an amount, with respect to the total composition, from about 5 g/L to about 15 g/L; and
(i) wherein the core comprises no more than 3% of oil solvent with respect to the total weight of the core.

26. The composition of claim 15, wherein the composition further comprises one or more additional inert ingredients.

27. The composition of claim 15, wherein the composition further comprises one or more additional active ingredients.

28. The composition of claim 27, wherein the one or more additional active ingredients is pyroxsulam, florasulam, cloquintocent mexyl, a compound of the formula (I) or a C₁-C₆ alkyl ester thereof; 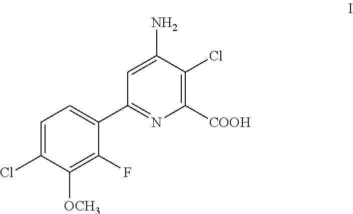 [SMILES: COc1c(Cl)ccc(-c2cc(N)c(Cl)c(C(=O)O)n2)c1F]
or a compound of formula (II) or a or a C₁-C₁₂ alkyl or C₇-C₁₂ arylalkyl ester thereof. 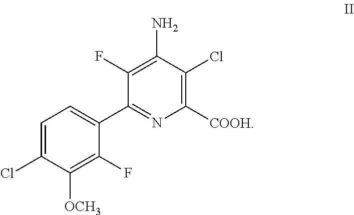 [SMILES: COc1c(Cl)ccc(-c2nc(C(=O)O)c(Cl)c(N)c2F)c1F]
